(19) United States
(12) Patent Application Publication
(10) Pub. No.: US 2004/0078928 A1
(43) Pub. Date: Apr. 29, 2004

(54) SM-02 screen door closing device

(76) Inventors: Calvin Roberts, Leucadia, CA (US); Randy Blumhagen, San Diego, CA (US)

Correspondence Address: US CORPORATIONS, INC., 630 NEPTUNE AVE., ENCINITAS, CA, 92024, US

(21) Appl. No.: 10/389,345

(22) Filed: Mar. 14, 2003

Related U.S. Application Data
(60) Provisional application No. 60/364,669, filed on Mar. 15, 2002.

(51) Int. Cl. E05D 13/00

(52) U.S. Cl. 16/210

(57) ABSTRACT

A device for closing a sliding screen door is disclosed. The inventive device includes a chassis mountable proximal to a sliding screen door. A retractable cable extends from the chassis, which is attached to a weighted housing with the sliding screen door to effect closing of the door subsequent to opening thereof.

### CROSS-REFERENCE TO RELATED APPLICATION

This application relies on a previously filed provisional application 60/364,669 filed 031502.

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

The present invention relates to automatic closures and more particularly pertains to a sliding screen door closing device for closing a sliding screen door.

2. Description of the Prior Art

The use of automated screen door closing devices is known in the prior art. More specifically, automatic closures heretofore devised and utilized are known to consist basically of familiar, expected and obvious structural configurations, notwithstanding the myriad of designs encompassed by the crowded prior art which have been developed for the fulfillment of countless objectives and requirements.

Known prior art automatic closures include U.S. Pat. No. 4,004,372; U.S. Pat. No. 5,131,188; U.S. Pat. No. 4,884,369; U.S. Pat. No. 3,828,393; U.S. Pat. No. 5,285,596; U.S. Pat. No. 5,247,763; and U.S. Pat. No. 4,149,295.

While these devices fulfill their respective, particular objectives and requirements, the aforementioned patents do not disclose a sliding screen door closing device for closing a sliding screen door which includes a chassis, weight carrier assembly, door bracket, cover, pulleys, and a retractable cable assembly to a sliding screen door, and a retractable cable y extending from the weight and coupling with the screen door to effect closing of the door subsequent to opening thereof.

In these respects, the sliding screen door closing device according to the present invention substantially departs from the conventional concepts and designs of the prior art, and in so doing provides an apparatus primarily developed for the purpose of effecting automatic closing of a sliding screen door.

### SUMMARY OF THE INVENTION

In view of the foregoing disadvantages inherent in the known types of automatic closures now present in the prior art, the present invention provides a new sliding screen door closing device construction wherein the same can be utilized for closing a sliding screen door. As such, the general purpose of the present invention, which will be described subsequently in greater detail, is to provide a new sliding screen door closing device apparatus and method which has many of the advantages of the automatic closures mentioned heretofore and many novel features that result in a sliding screen door closing device which is not anticipated, rendered obvious, suggested, or even implied by any of the prior art automatic closures, either alone or in any combination thereof.

To attain this, the present invention generally comprises a device for closing a sliding screen door. The inventive device includes a chassis, weight carrier assembly, door bracket, cover, pulleys, and a retractable weighted cable assembly. A weighted cable extends from the weight and couples with the sliding screen door to effect closing of the door subsequent to opening thereof.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new sliding screen door closing device apparatus and method which has many of the advantages of the automatic closures mentioned heretofore and many novel features that result in a sliding screen door closing device which is not anticipated, rendered obvious, suggested, or even implied by any of the prior art tool guides, either alone or in any combination thereof.

It is another object of the present invention to provide a new sliding screen door closing device which may be easily and efficiently manufactured and marketed.

It is a further object of the present invention to provide a new sliding screen door closing device which is of a durable and reliable construction.

An even further object of the present invention is to provide a new sliding screen door closing device which is susceptible of a low cost of manufacture with regard to both materials and labor, and which accordingly is then susceptible of low prices of sale to the consuming public, thereby making such sliding screen door closing devices economically available to the buying public.

Still yet another object of the present invention is to provide a new sliding screen door closing device which provides in the apparatuses and methods of the prior art some of the advantages thereof, while simultaneously overcoming some of the disadvantages normally associated therewith.

Still another object of the present invention is to provide a new sliding screen door closing device for effecting closing of a sliding screen door.

Yet another object of the present invention is to provide a new sliding screen door closing device which includes a chassis, weight carrier assembly, door bracket, cover, pulleys, and a retractable cable assembly with the sliding screen door to effect closing of the door subsequent to opening thereof.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

This gravity powered closer is specifically designed to automatically close a sliding screen door. Unlike other patented devices, the front cover of this device houses a decorative insert that can accommodate any design style. The device is mounted on the exterior wall adjacent to the top corner of the doorframe where the door opens. Unlike other patented devices, this device is very compact requiring a very small rectangular mounting footprint. A tension cable is connected to the screen door through an extended travel path to the internal counter ballast. Unlike other patented devices, this counter ballast can be adjusted to the specific weight of each screen door, thereby generating a recoilless closing action. When opened, the screen door slides freely as if not weighted at all. When released, nearly balanced, closing force is applied by the counter ballast and the screen door gently closes automatically without obstruction.

In patio doors ranging in size from 6 feet wide up to 10 feet wide, an esthetically designed, competitively priced closing device for the sliding screen door is not commercially available. A number of inventors have responded to this problem by designing devices that consist of intricate, multiple moving parts housed in elongated tubular shaped casings. However, multiple moving parts are cost prohibitive to manufacture and assemble, while elongated tubular shapes are difficult to ship and nearly impossible to merchandise and require professional installation. Most inventors have focused attention only to the closing action applied to heavy sliding glass doors overlooking the lighter weight sliding screen door. Their designs resemble garage shop assemblages with no attention directed to esthetics. This combination of design deficiencies translates directly into merchandiser disinterest.

The current device concentrates on the safety and convenience afforded to a device specifically designed to close sliding screen doors. We incorporate compact space requirements with extended travel paths and ease of installation. Our device is sensitive to esthetic appearance complimenting existing design styles. We overcome merchandising problems associated with elongated casings with our compact footprint design. We overcome the expense of intricate moving parts with a simple gravity powered machine. We overcome the recoil problem caused by acceleration in elongated casings with compact internal travel paths. And we are the only sliding screen door closing invention that incorporates a decorative insert designed to complement any existing design style.

The current device is a simple gravity powered machine consists of a chassis, weight carrier assembly, door bracket, cover, pulleys, and a retractable cable assembly. The chassis is mounted on the wall next to the sliding door and sliding screen and is positioned adjacent to the upper screen doorframe through the holes provided. It can be mounted for left or right operation simply by removing screw and the cable loop from one side and reinserting screw through the loop in the opposite end of the cable into the screw mounting position on the other side of the unit. The door bracket is mounted onto the upper frame of the sliding screen door. The exposed loop in the cable is then attached to the door bracket. Weights are systematically added into or removed from the weight carrier to provide enough pulling force on the cable and door bracket to close the sliding screen door. Once the unit has been installed and adjusted, the cover is installed over the chassis and weight assemblies and the decorative insert placed in the grooves and the end-caps are installed.

The operation of the sliding screen door closer is when a person wishes to enter or exit the house via the opening that has a sliding screen door with an automatic closer installed, they will open the door as usual by sliding the screen door open. This process will pull the cable assembly from the unit via the internal pulleys attached in the chassis and the weight assembly. This will raise the weight assembly from it's slightly loaded “at rest” position and store energy so that after the person traverses the opening they will release the door. At this time the stored energy in the weight assembly will be released and the assembly will travel downward pulling the cable assembly back into the unit. This action will pull on the door bracket attached to the sliding screen door and thus close the sliding screen door automatically.

### BRIEF DESCRIPTION

Illlustrations

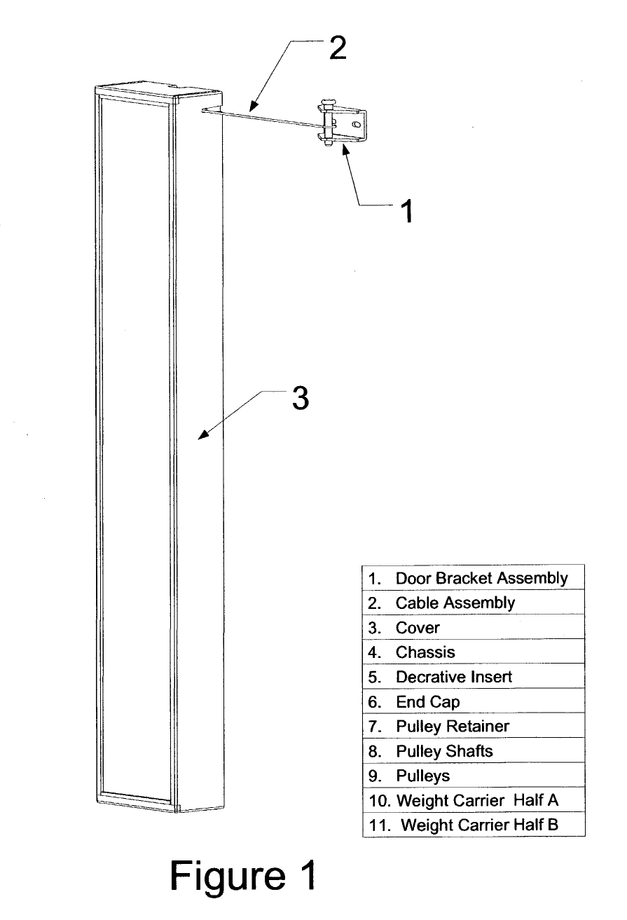

FIG. 1

A perspective view of the front and right side of the device, cable and door bracket assembly.

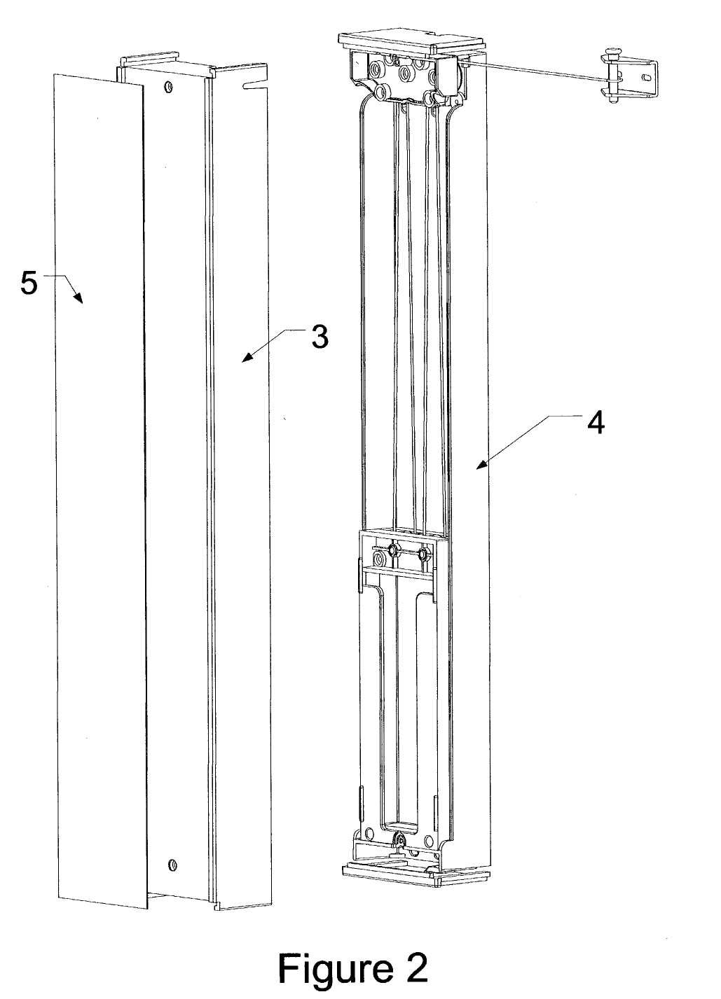

FIG. 2

A perspective view of the right cover, decorative trim piece and chassis.

### DETAILED DESCRIPTION OF THE PREFERRED EMBODIMENT

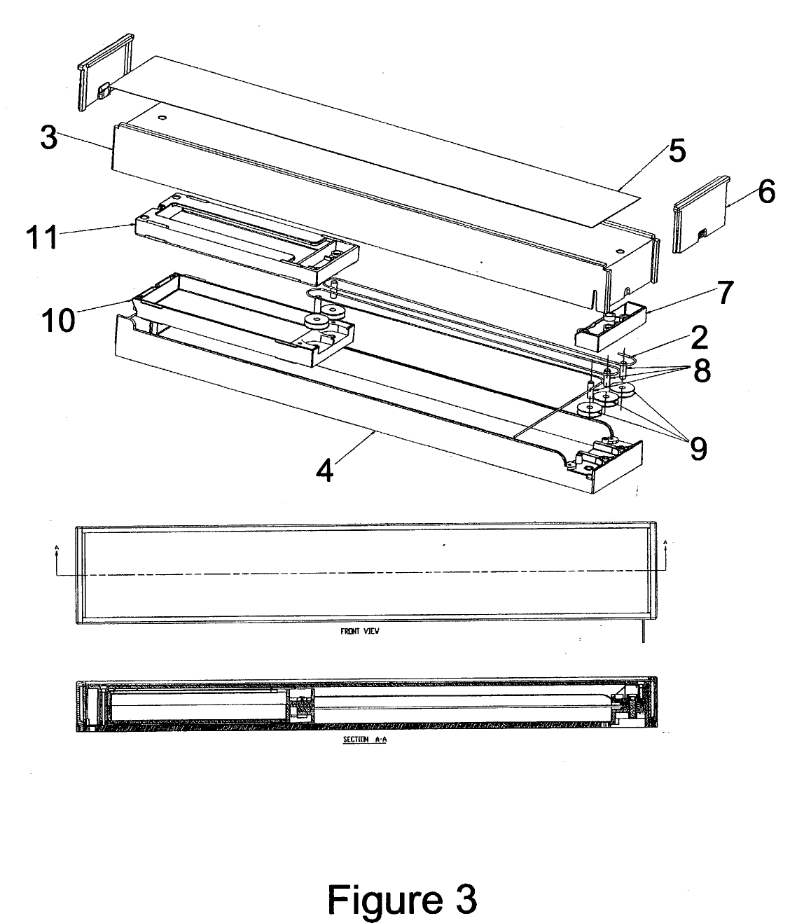

Referring now to FIGS. 1, 2 and 3, the sliding screen door closing device of the present invention is used in conjunction with a standard exterior sliding screen door not shown. The sliding screen door closing device will connect to the sliding screen door with the door bracket assembly 1. The door bracket assembly 1 will be drawn to the device therein and related cover 3, by the cable assembly 2. This cable assembly 2 is drawn under gravitational pull created by the weight carrier 10 and 11 respectively. In order to allow for necessary travel of the door bracket assembly 1, as to account for different sized screen doors, pulleys 9, on pulley shafts 8 are used and held in perspective positions by the pulley retainer 7.

The sliding screen door device of the present invention is contained within the chassis 4, and cover 3, respectively. The cover 3 maintains an ethically pleasing presence due to the color coordinated decorative insert 5 and the end caps 6.

What is claimed as being new and desired to be protected is as follows:

1. A sliding screen door closing device comprising:
a closure means for effecting movement of a sliding screen door along a linear track in a predetermined direction so as to effect closing of the sliding screen door subsequent to opening thereof, the closure means comprises a chassis mountable to a portion of a building adjacent to a sliding screen door; a door bracket assembly, cable stored within the chassis which can be resiliently extended there from, the cable extending from the chassis and being couplable to a portion of the sliding screen door, whereby opening of the sliding screen door will effect extension of the cable which is attached across the pulley retainer and pulleys to the weighted assembly, with a releasing of the sliding screen door resulting in a resilient retraction of the cable, due to the gravitational pull of the weight within the weight carriers to effect closing of the sliding screen door, the closure means further comprises a cover, pulleys, pulley retainer, end cap and decorative insert with the cable being strung across such pulleys and being attached to the screen door at one end and being attached to the weighted assembly at the apposing end.

2. A sliding screen door closing device according to claim 1 wherein the weight carrier is adjustable in weight.

3. A sliding screen door closing device according to claim 1 wherein the device mounts on the exterior of any building parallel to the subject door.

4. A sliding screen door closing device according to claim 1 wherein the weight carrier can be adjusted to increase or decrease pull on the cable and related screen door.

5. A sliding screen door closing device according to claim 1 wherein a decorative insert attaches to the exterior of the device for aesthetic purposes.
